(19) United States
(12) Patent Application Publication
(10) Pub. No.: US 2013/0264301 A1
(43) Pub. Date: Oct. 10, 2013

(54) HOIST APPARATUS

(71) Applicant: SAMSUNG Electronics Co., Ltd, Suwon-si (KR)

(72) Inventors: Sung-hak KIM, Seoul (KR); Young-hoon LEE, Seongnam-si (KR); Chul-jun PARK, Seoul (KR)

(73) Assignee: SAMSUNG Electronics Co., Ltd., Suwon-si (KR)

(21) Appl. No.: 13/800,089

(22) Filed: Mar. 13, 2013

(30) Foreign Application Priority Data
Apr. 5, 2012 (KR) 10-2012-0035599

(51) Int. Cl. B66C 19/00

(52) U.S. Cl. CPC B66C 19/00
USPC 212/71; 105/148

(57) ABSTRACT

A hoist apparatus includes a traveling portion disposed to travel along a transfer path, a rotation portion installed at the traveling portion to rotate with respect to the traveling portion, an ascending and descending portion to ascend or descend with respect to the rotation portion and for loading an object, and an object support member installed at the traveling portion, having an accommodation space to accommodate the object, and including at least one object support portion disposed at one side of the object support member and having a shape corresponding to the object so as to support the object rotated by the rotation portion.

### CROSS-REFERENCE TO RELATED APPLICATIONS

This application claims priority under 35 U.S.C. §119 from Korean Patent Application No. 10-2012-0035599, filed on Apr. 5, 2012, in the Korean Intellectual Property Office, the disclosure of which is incorporated herein in its entirety by reference.

### BACKGROUND

1. Field

The inventive concept relates to a hoist apparatus, and more particularly, to a hoist apparatus that may prevent an object from falling by securely fixing the object when the object is transferred and that allows the object to be stably transferred.

2. Description of the Related Art

In general, hoist apparatuses are referred to as apparatuses that hoist and transfer an object. Hoist apparatuses are used in freight transport and machine disassembly and assembly in factories, warehouses, train stations, and the like. Hoist apparatuses are also used in transferring logistics in factories for semiconductors or display panels, such as liquid crystal displays (LCDs), plasma display panels (PDPs), and the like, and in clean rooms.

### SUMMARY

The inventive concept provides a hoist apparatus that may prevent an accommodation object from escaping from an accommodation container and from falling therefrom, that may protect an object including the accommodation object and the accommodation container from external shock or vibration by securely fixing the accommodation container on a traveling portion when the object is transferred, and that may improve durability of a hoist belt by dispersing a load of the object into an object support member.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a hoist apparatus including a traveling portion to travel along a transfer path, a rotation portion installed at the traveling portion to rotate with respect to the traveling portion, an ascending and descending portion to ascend and descend with respect to the rotation portion and to load an object, and an object support member installed at the ascending and descending portion of the traveling portion, having an accommodation space in which the object is accommodated, and including at least one object support portion disposed at one side of the object support member and having a shape corresponding to the object so as to support the object rotated by the rotation portion.

The object may include an accommodation container to accommodate at least one accommodation object.

The object support member may include a protection frame having an object inlet/outlet through which the object passes and that is formed at one side of the protection frame, the protection frame surrounding the object partially to protect the object.

The at least one object support portion may be formed around the object inlet/outlet of the protection frame.

The at least one object support portion may include object support blocks having object support grooves formed to correspond to edges of the object, respectively.

The object support grooves may include a first inner contact side and a second inner contact side that contact the object and that form a right angle to each other according to a plan view.

A length of the first inner contact side may be larger than a length of the second inner contact side.

A length of the first inner contact side and a length of the second inner contact side may be the same.

The at least one object support portion may include guide inclined surfaces on which edges of the object are guided in a direction of the object support grooves formed to correspond to the edges of the object, respectively.

The at least one object support portion may include four object support blocks in which object support grooves are formed to correspond to four edges of the object, respectively.

The at least one object support portion may be integrated with one side of the protection frame having an object inlet/outlet through which the object passes and that is formed at one side of the protection frame, the protection frame surrounding the object partially and for protecting the object.

The at least one object support portion may include an object support block formed with object support grooves to correspond to four edges of the object, respectively, and a shock-alleviating block formed of an elastic material to alleviate shock applied to the object support block.

The at least one object support portion may include an object support block formed with object support grooves to correspond to four edges of the object, respectively, and an elastic spring that alleviates shock applied to the object support block.

The traveling portion may be installed in such a way that a transfer leveling cart having wheels that roll along rails is connected to one side of the traveling portion.

The foregoing and/or other features and utilities of the present general inventive concept may also be achieved by providing a hoist apparatus including a traveling portion to travel along rails, and an object support member installed at the traveling portion, having an accommodation space in which the object is accommodated, and including at least one object support groove formed at one side of the object support member and having a shape corresponding to a corresponding edge of the object so as to support the rotated object.

The foregoing and/or other features and utilities of the present general inventive concept may also be achieved by providing a hoist apparatus including an object support member having an accommodation space to accommodate an object, and having at least one groove formed at a corresponding side of the object support member and having a shape corresponding to a corresponding edge of the object so as to support the object rotated with respect to the object support member.

The object support member may include at least one horizontal member and at least one object support block disposed on the horizontal member. The at least one groove may be formed on the corresponding object support block.

The object support member may include at least one horizontal member. The groove may be formed in the horizontal member.

The object support member may include sub-members to form a plane shape to correspond to the object. The groove may be disposed at a plane shape having an angle with the plane shape of the object support member.

The object support member may include a plurality of horizontal members disposed at corners of an area, the groove may include a plurality of grooves disposed at corners of another area to correspond to corners of the object, and the corners of the area and corners of the another area may not overlap.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a perspective view illustrating a hoist apparatus according to an embodiment of the inventive concept;

FIG. 2 is an exploded perspective view illustrating each of object support blocks of the hoist apparatus illustrated in FIG. 1;

FIG. 3 is a plan view illustrating each object support block and a protection frame of the hoist apparatus of FIG. 1;

FIG. 4 is a perspective view illustrating object support grooves and guide inclined surfaces of each object support block of the hoist apparatus of FIG. 1;

FIG. 5 is a plan view illustrating one object support block of the hoist apparatus of FIG. 1;

FIG. 6 is a plan view illustrating an object support block usable with a hoist apparatus according to an embodiment of the inventive concept;

FIG. 7 is a perspective view illustrating an operating state of an operation of hoisting an object by using the hoist apparatus of FIG. 1;

FIG. 8 is a perspective view illustrating an operating state of an operation of rotating an object by using the hoist apparatus of FIG. 1;

FIG. 9 is a perspective view illustrating an operating state of an operation of lowering an object by using the hoist apparatus of FIG. 1;

FIG. 10 is a perspective view illustrating an operating state of an operation of fixing an object by using the hoist apparatus of FIG. 1;

FIG. 11 is an exploded perspective view illustrating an object support block usable with a hoist apparatus according to an embodiment of the inventive concept;

FIG. 12 is an exploded perspective view illustrating an object support portion usable with a hoist apparatus according to an embodiment of the inventive concept;

FIG. 13 is an exploded perspective view illustrating an object support portion usable with a hoist apparatus according to an embodiment of the inventive concept;

FIG. 14 is an exploded perspective view illustrating an object support portion usable with a hoist apparatus according to an embodiment of the inventive concept;

FIG. 15 is an exploded perspective view illustrating an object support portion usable with a hoist apparatus according to an embodiment of the inventive concept;

FIG. 16 is a perspective view illustrating a traveling state of a hoist apparatus, according to an embodiment of the inventive concept; and

FIG. 17 is a perspective view of a traveling state of a hoist apparatus according to an embodiment of the inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The attached drawings for illustrating exemplary embodiments of the inventive concept are referred to in order to gain a sufficient understanding of the inventive concept, the merits thereof, and the objectives accomplished by the implementation of the inventive concept. The inventive concept may, however, be embodied in many different forms and should not be construed as being limited to the embodiments set forth herein; rather, these embodiments are provided so that this disclosure will be thorough and complete, and will fully convey the concept of the inventive concept to those skilled in the art. In addition, in the drawings, a thickness or size of each layer is exaggerated for convenience and clarity.

It will be understood that when an element, such as a layer, a region, or a substrate, is referred to as being “on,” “connected to,” or “coupled to” another element, it may be directly on, connected to, or coupled to the other element or intervening elements may be present. In contrast, when an element is referred to as being “directly on,” “directly connected to,” or “directly coupled to” another element, there are no intervening elements present. This applies to interpretation of other expressions for describing the relationship between elements, i.e., “between˜” and “directly between˜”, or “adjacent to˜”and “directly adjacent to˜”. Like reference numerals denote like elements. As used herein, the term “and/or” includes any and all combinations of one or more of the associated listed items.

It will be understood that, although the terms first, second, third, etc. may be used herein to describe various elements, components, regions, layers, and/or sections, these elements, components, regions, layers, and/or sections should not be limited by these terms. These terms do not refer to a particular order, rank, or superiority and are only used to distinguish one element, component, region, layer, or section from another element, component, region, layer, or section. Thus, a first element, component, region, layer, or section discussed below could be termed a second element, component, region, layer, or section without departing from the teachings of the example embodiment. For example, a first element may be referred to as a second element, and similarly, a second element may be referred to as a first element without departing from the scope of protection of the inventive concept.

Spatially relative terms, such as “above” or “upper” and “below” or “lower”, and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the inventive concept. As used herein, the singular forms “a,” “an,” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Hereinafter, exemplary embodiments of the inventive concept will be described with reference to accompanying drawings schematically illustrating the embodiments. In the drawings, for example, illustrated shapes may be deformed according to fabrication technology and/or tolerances. Therefore, the exemplary embodiments of the inventive concept are not limited to certain shapes illustrated in the present specification, and may include modifications of shapes caused in fabrication processes.

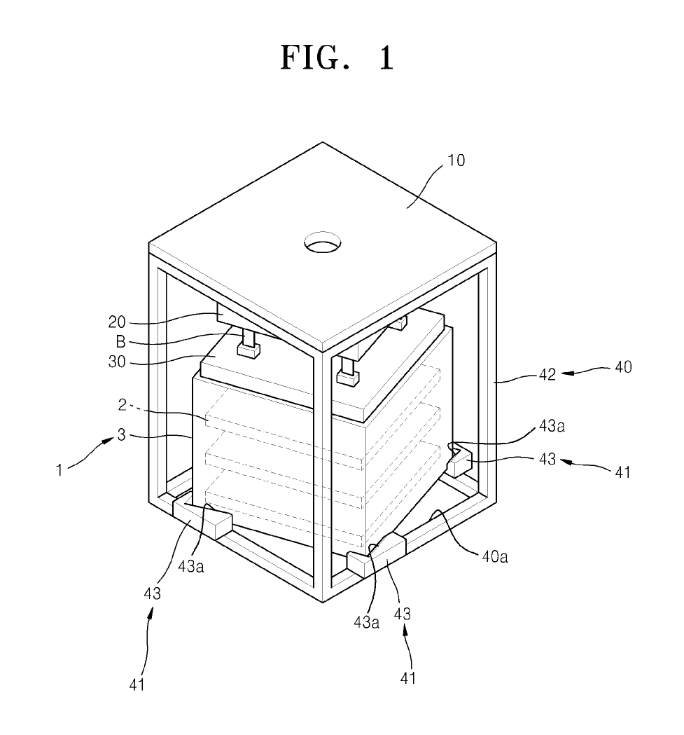

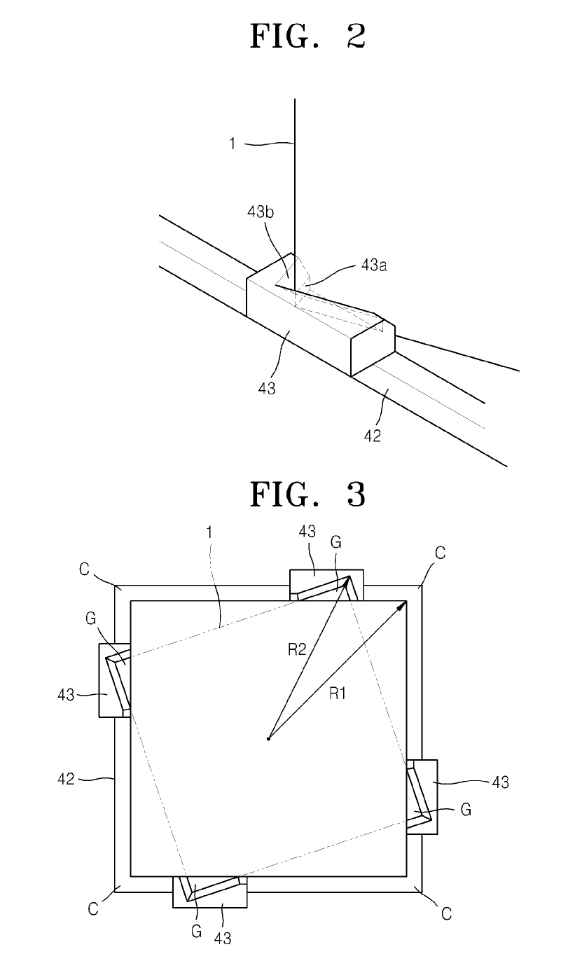

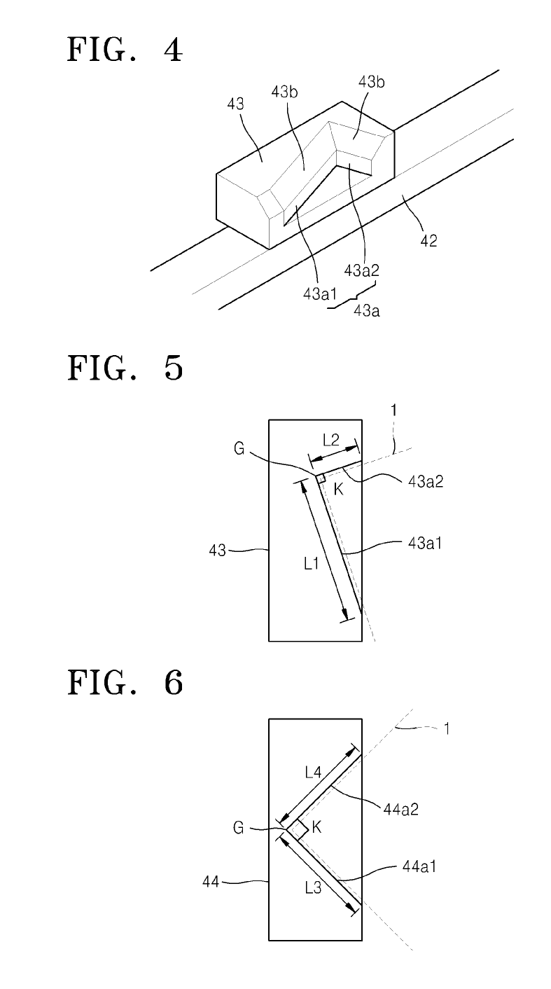

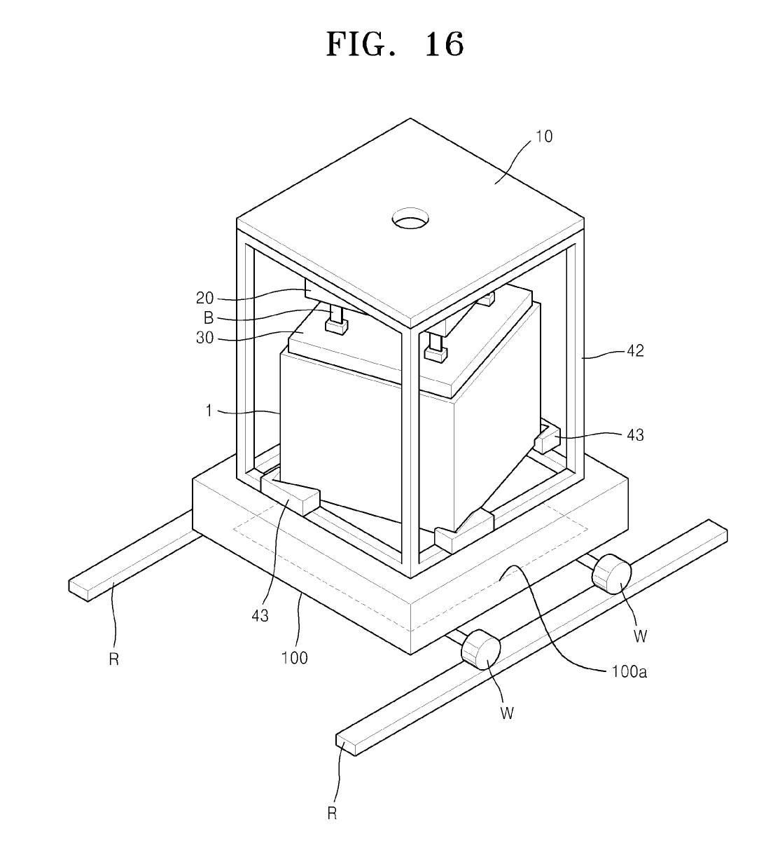

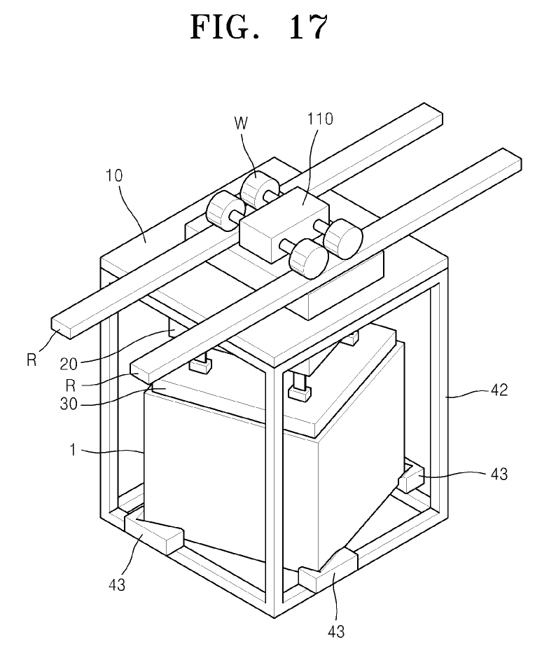

FIG. 1 is a perspective view illustrating a hoist apparatus according to an embodiment of the inventive concept, FIG. 2 is an exploded perspective view illustrating each of object support blocks 43 of the hoist apparatus of FIG. 1, FIG. 3 is a plan view illustrating each object support block 43 and a protection frame 42 of the hoist apparatus of FIG. 1, FIG. 4 is a perspective view illustrating object support grooves 43a and guide inclined surfaces 43b of each object support block 43 of the hoist apparatus of FIG. 1, FIG. 5 is a plan view illustrating one object support block 43 of the hoist apparatus of FIG. 1, and FIGS. 16 and 17 are perspective views illustrating traveling states of the hoist apparatus, according to an embodiment of the inventive concept.

As illustrated in FIGS. 1 through 5, the hoist apparatus according to an embodiment of the inventive concept may include a traveling portion 10, a rotation portion 20, an ascending and descending portion 30, and an object support member 40.

The traveling portion 10 may travel along one or more transfer paths having various shapes, such as rails R installed on a ceiling, in the air, on a floor, on a wall, or the like of a semiconductor line, a factory, a working room, or the like, as illustrated in FIGS. 1, 16, and 17. In these drawings, for conveniences of explanation, traveling devices, such as transfer leveling carts 100 and 110 or wheels W that will be described later, are omitted, and only panels on which various traveling devices may be connected to each other, are illustrated.

In addition, the rotation portion 20 may be connected to and installed at the traveling portion 10 and may rotate right and left (or clockwise or counterclockwise direction) based on the traveling portion 10, as illustrated in FIG. 1.

The rotation portion 20 is installed at the traveling portion 10, and various rotation driving devices that rotate and are driven by motors to which power is supplied via rails R or other electric wires may be installed at the rotation portion 20. Here, a detailed description of the rotation portion 20 will be omitted.

The ascending and descending portion 30 may ascend or descend via a belt B that is connected to the rotation portion 20 and may be wound or unwound around a pulley based on the rotation portion 20, and an object 1 may be loaded on a lower portion of the ascending and descending portion 30.

The ascending and descending portion 30 may be various pickup devices or ascending and descending devices that may use the belt B to hoist or lower the object 1. However, the pickup devices or ascending and descending devices are well known, and thus a detailed description thereof will be omitted.

The object 1 may be an accommodation container 3 to accommodate at least one accommodation object 2. The accommodation object 2 may be various semiconductor devices, wafers, lead frames, printed circuit boards (PCBs), rings, masks, display panels, such as light emitting diode (LED) panels, liquid crystal display (LCD) panels, plasma display panel (PDP) panels, and organic light-emitting display panels, and the like, and the accommodation container 3 may be a cassette, a magazine, or the like on which the above-described accommodation object 2 is loaded.

As illustrated in FIG. 1, the object support member 40 is connected to and installed at the traveling portion 10, has an accommodation space in which the object 1 is accommodated, and includes at least one object support portion 41 disposed at one side of the object support member 40 and having a shape corresponding to the object 1 so as to support the object 1 rotated by the rotation portion 20.

As illustrated in FIG. 1, the object support member 40 may include a protection frame 42 having an object inlet/outlet 40a through which the object 1 passes and that is formed at one side of the protection frame 42 in a downward direction of the protection frame 42 and having a rectangular pillar shape so as to partially surround and protect the object 1. Part of each of side portions of the protection frame 42 may be open so that the object 1 does not collide with the side portions when the object 1 is rotated, as illustrated in FIG. 1.

In addition, the object support portion 41 may be formed on a top surface of the protection frame 42 around the object inlet/outlet 40a of the protection frame 42.

The object support portion 41 may be four object support blocks 43 having four object support grooves 43a formed to correspond to four edges of the object 1, as illustrated in FIGS. 3 and 4.

As illustrated in FIGS. 2 and 4, guide inclined surfaces 43b on which the edges of the object 1 are guided in a direction of the object support grooves 43a, may be formed on each of the object support blocks 43.

As illustrated in FIGS. 4 and 5, the object support groove 43a of each object support block 43 may include a first inner contact side 43a1 and a second inner contact side 43a2 that contact the object 1 and that are at right angles (K) to each other according to a plan view, so that the object support grooves 43a may correspond to the edges of the object 1 when the entire shape of the object 1 is a rectangular pillar shape, for example.

In addition, as illustrated in FIG. 5, the first inner contact side 43a1 may have a length L1 that is greater than a length L2 of the second inner contact side 43a2. Thus, as illustrated in FIG. 3, each of the object support blocks 43 may be inclined in one direction towards four sides of the protection frame 42 so as to minimize rotation of the object 1.

The object support blocks 43 are disposed on a line between adjacent corners C of the protection frame 42. The object support blocks 43 are disposed at a portion having a first distance from a corner C of the protection frame 42 and a second distance from another corner C of the protection frame 42, and the one of the first distance and the second distance is longer than the other one such that the object rotates by a an angle A with respect to the protection frame 42.

The protection frame 42 may include a plurality of vertical members and a plurality of horizontal members disposed between the adjacent vertical members. FIGS. 1 and 3 illustrate four vertical members and four horizontal members, for example. The object support blocks 43 may be disposed on the horizontal members. The object 1 may be disposed on a plane formed by the object support blocks 43, and the plane may not be the same plane as formed by the four vertical members.

The object support blocks 43 each may have a corner G to correspond to a corner of the object 1, and the corner G may be disposed on the horizontal member. It is possible that the corner G of the object support blocks 43 may not protrude from the horizontal member of the protection frame 42. However, the present general inventive concept is not limited thereto. It is possible that a distance from a center portion of the object 1 or the protection frame 42 to the corner C of the protection frame 43 may be referred to R1, and a distance from the center portion of the object 1 or the protection frame 42 to the corner G of the object support block 43 is referred to as R2 which may be shorter than the distance R1. It is also possible that the distance R1 may be same as the distance R2.

FIG. 6 is a plan view illustrating one or more object support blocks 44 according to an embodiment of the inventive concept.

As illustrated in FIG. 6, the object support blocks 44 may have a first inner contact side 44a1 and a second inner contact side 44a2, wherein a length L3 of the first inner contact side 44a1 is the same as a length L4 of the second inner contact side 44a2.

An operation of the hoist apparatus illustrated in FIG. 1, according to an embodiment of the inventive concept, will now be described in greater detail.

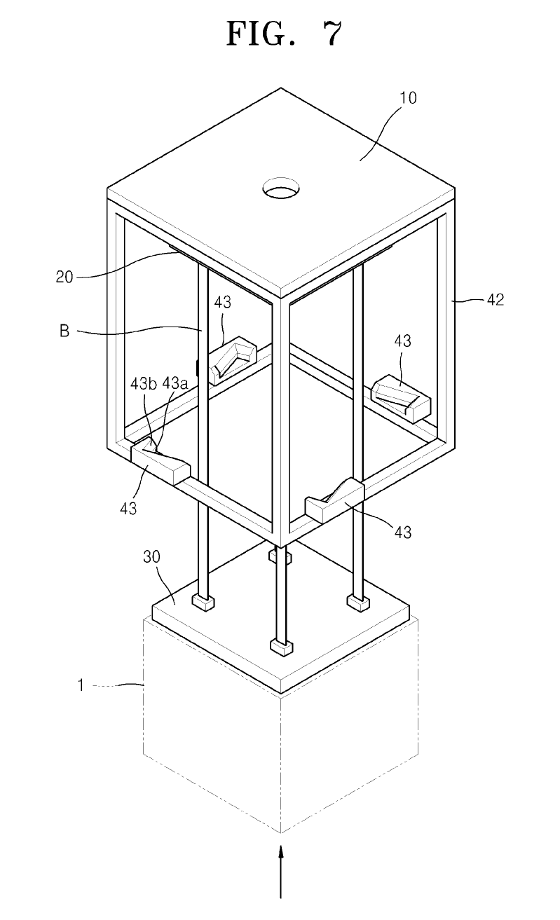

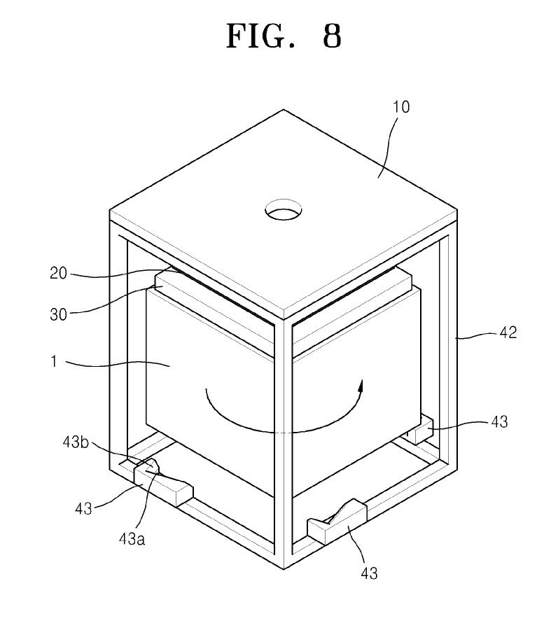

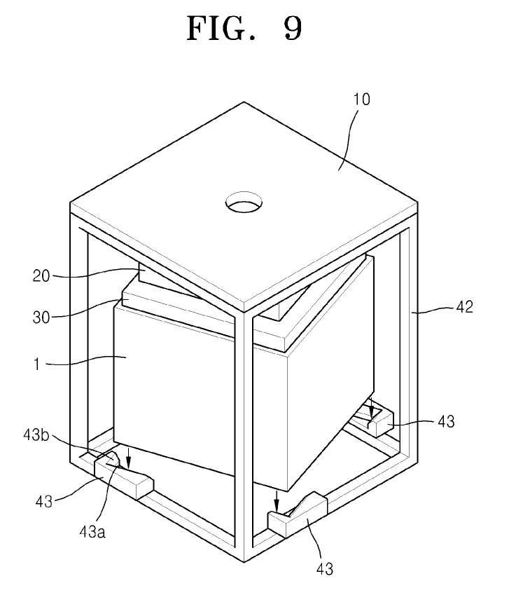

FIG. 7 is a perspective view illustrating an operating state of an operation of hoisting the object 1 by using the hoist apparatus of FIG. 1, FIG. 8 is a perspective view illustrating an operating state of an operation of rotating the object 1 by using the hoist apparatus of FIG. 1, FIG. 9 is a perspective view illustrating an operating state of lowering the object 1 by using the hoist apparatus of FIG. 1, and FIG. 10 is a perspective view illustrating an operating state of an operation of fixing the object 1 by using the hoist apparatus of FIG. 1.

First, as illustrated in FIG. 7, in the operation of hoisting the object 1, the ascending and descending portion 30 in which the object 1 is loaded may hoist the object 1 in a direction of the traveling portion 10 via the belt B based on the rotation portion 20.

As illustrated in FIG. 8, in the operation of rotating the object 1, if the object 1 is hoisted to a height that is equal to or greater than a height of the object support blocks 43 after undergoing the operation of hoisting the object 1, the object 1 stops ascending, and the rotation portion 20 may rotate together with the object 1 in a direction of the object support blocks 43 at a predetermined angle so that the edges of the object 1 may be disposed above the object support blocks 43.

As illustrated in FIG. 9, in the operation of lowering the object 1, the ascending and descending portion 30 may be lowered via the belt B until the edges of the object 1 disposed above the object support blocks 43 reach the object support grooves 43a of the object support blocks 43.

As illustrated in FIG. 10, in the operation of fixing the object 1, the edges of the object 1 are lowered by the belt B, are guided along the guide inclined surfaces 43b of the object support blocks 43, and are finally securely fixed on the object support grooves 43a of the object support block 43. The object 1 may travel along the rails R at a high speed safely by using the transfer leveling carts 100 and 110 and the wheels W illustrated in FIG. 16 or 17 in the state where the object 1 is securely fixed on the object support blocks 43.

In this case, since four edges of the object 1 may be securely landed and fixedly disposed on four object support blocks 43, the accommodation object 2 may be prevented from escaping from the accommodation container 3 due to shock, vibration, or shake during traveling, and the object 1 including the accommodation object 2 and the accommodation container 3 may be protected from an external shock or vibration during traveling.

In addition, a load of the object 1 during traveling may be dispersed into the object support member 40 and thus durability of the belt B may be improved. In addition, the object support blocks 43 may be easily installed at the protection frame 42 without additionally installing separate complicated components and thus manufacturing cost of the hoist apparatus may be greatly reduced.

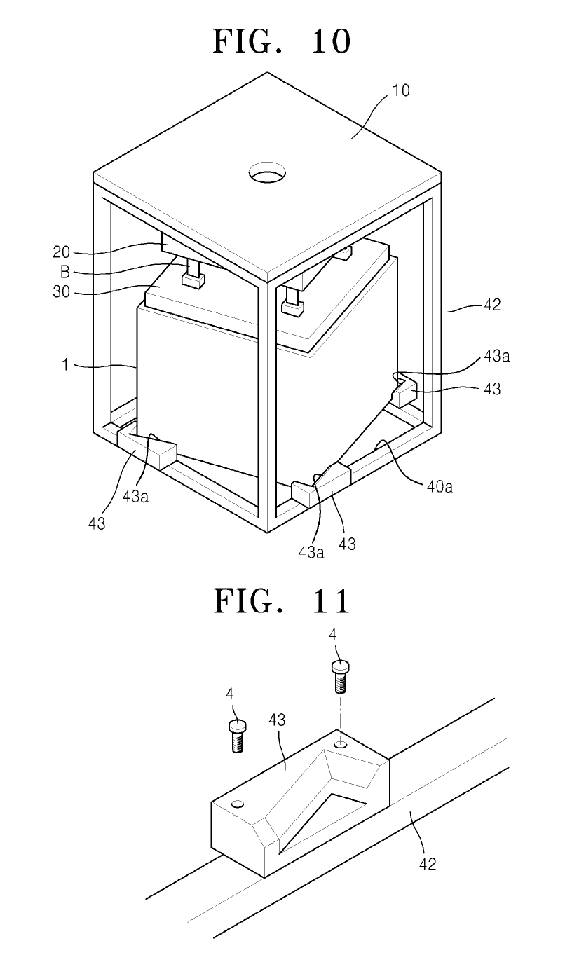

FIG. 11 is an exploded perspective view illustrating one or more object support blocks 43 of FIG. 1 according to an embodiment of the inventive concept.

Referring to FIG. 11, the object support blocks 43 may be installed at the protection frame 42 by using a connecting element, such as bolts, screws, and the like, so that the object support blocks 43 may be easily exchanged when worn out due to frequent collision with the object 1.

FIG. 12 is an exploded perspective view illustrating an object support portion 51 according to an embodiment of the inventive concept.

Referring to FIG. 12, the object support portion 51 may be a protection frame 52 having an object inlet/outlet 50a through which the object 1 passes. The object support portion 51 may be formed at one side of the protection frame 52 and may include object support grooves 53a integrated with one side of the protection frame 52 that surrounds the object 1 partially to protect the object 1. The protection frame 52 having the object support portion 51 may correspond to a structure of the horizontal member of the protection frame 43 of FIG. 1 with the object support portion 51 formed therein and without the object support block 43 formed thereon.

Here, guide inclined surfaces 53b on which edges of the object 1 are guided in a direction of the object support grooves 53a formed to correspond to the edges of the object 1, may be integrated with the protection frame 52.

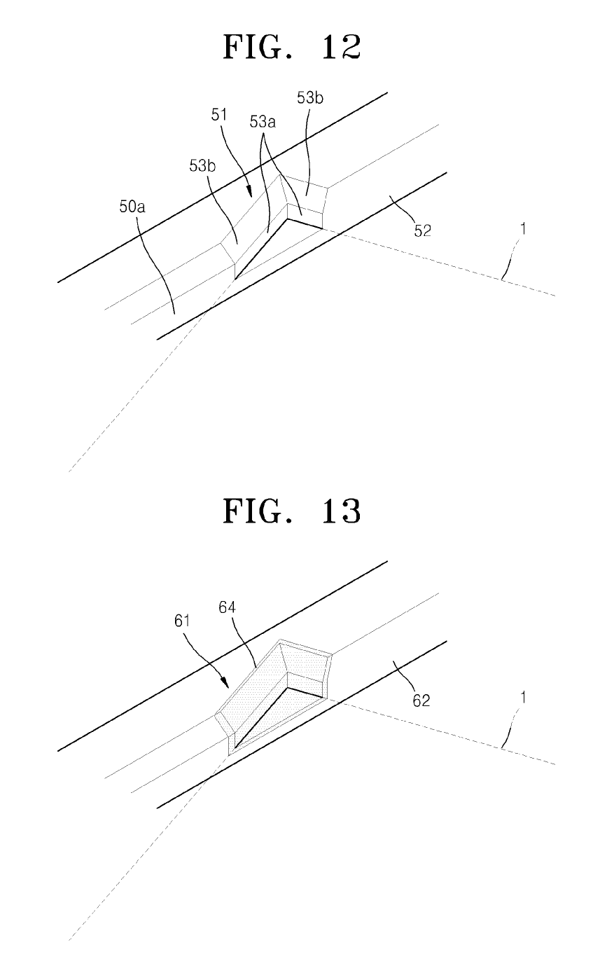

FIG. 13 is an exploded perspective view illustrating an object support portion 61 according to an embodiment of the inventive concept.

Referring to FIG. 13, an elastic body 64 may be installed between the object support portion 61 of a protection frame 62 and the object 1 in order to alleviate shock applied thereto.

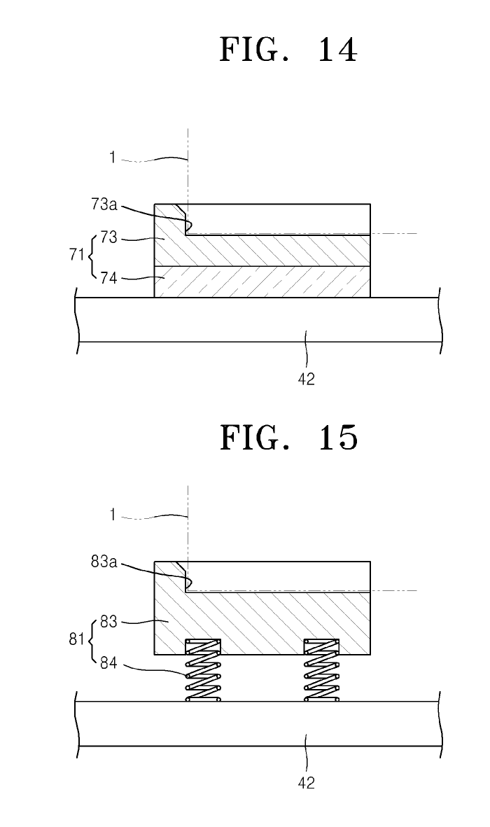

FIG. 14 is a cross-sectional view illustrating an object support portion 71 according to an embodiment of the inventive concept.

Referring to FIG. 14, the object support portion 71 may include an object support block 73 having object support grooves 73a formed to correspond to the edges of the object 1, and a shock-alleviating block 74 formed of an elastic material to alleviate shock applied to the object support block 73.

Thus, the shock-alleviating block 74 may alleviate shock caused by collision between the edges of the object 1 and the object support block 73 from being transferred to the protection frame 42 or from being transferred to the edges of the object 1.

FIG. 15 is a cross-sectional view illustrating an object support portion 81 according to an embodiment of the inventive concept.

Referring to FIG. 15, the object support portion 81 may include an object support block 83 having object support grooves 83a formed to correspond to the edges of the object 1, and an elastic spring 84 that alleviates shock applied to the object support block 83.

Thus, the elastic spring 84 may alleviate shock caused by collision between the edges of the object 1 and the object support block 83 from being transferred to the protection frame 42 or from being transferred to the edges of the object 1.

FIG. 16 is a perspective view illustrating a traveling state of a hoist apparatus, according to an embodiment of the inventive concept.

Referring to FIG. 16, the traveling portion 10 may be installed in such a way that the transfer leveling cart 100 having the wheels W, which roll along the rails R installed on a ceiling, in the air, on a wall, or the like of a working room, is connected to a lower portion of the traveling portion 10 via the protection frame 42.

In this case, the transfer leveling cart 100 has a through window 100a through which the object 1 may be hoisted or lowered.

Thus, as illustrated in FIG. 16, the object 1 is hoisted through the through window 100a. As described above, since four edges of the object 1 may be securely fixed on four object support blocks 43 after undergoing the operation of hoisting the object 1 of FIG. 7, the operation of rotating the object 1 of FIG. 8, the operation of lowering the object 1 of FIG. 9, and the operation of fixing the object 1 of FIG. 10, the accommodation object 2 may be prevented from escaping from the accommodation container 3 due to shock, vibration, or shake applied during traveling and from falling, and the object 1 including the accommodation object 2 and the accommodation container 3 may be protected from external shock or vibration during traveling.

FIG. 17 is a perspective view illustrating a traveling state of a hoist apparatus, according to an embodiment of the inventive concept.

Referring to FIG. 17, the traveling portion 10 may be installed in such a way that the transfer leveling cart 110 having the wheels W, which roll along the rails R installed on a ceiling or the like of a working room, is connected to an upper portion of the traveling portion 10.

Thus, as illustrated in FIG. 17, as described above, since four edges of the object 1 may be securely landed and fixedly disposed on corresponding ones of four object support blocks 43 after undergoing the operation of hoisting the object 1 of FIG. 7, the operation of rotating the object 1 of FIG. 8. and the operation of lowering the object 1 of FIG. 9, and the operation of fixing the object 1 of FIG. 10, the accommodation object 2 may be prevented from escaping from the accommodation container 3 due to shock, vibration, or shake applied during traveling and from falling, and the object 1 including the accommodation object 2 and the accommodation container 3 may be protected from external shock or vibration during traveling.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A hoist apparatus comprising:
a traveling portion disposed to travel along a transfer path;
a rotation portion installed at the traveling portion to rotate with respect to the traveling portion;
an ascending and descending portion to ascend and descent with respect to the rotation portion and to load an object; and
an object support member installed at the ascending and descending portion of the traveling portion, having an accommodation space in which the object is accommodated, and comprising at least one object support portion disposed at one side of the object support member and having a shape corresponding to the object so as to support the object rotated by the rotation portion.

2. The hoist apparatus of claim 1, wherein the object comprises an accommodation container to accommodate at least one accommodation object.

3. The hoist apparatus of claim 1, wherein the object support member comprises a protection frame having an object inlet/outlet through which the object passes and that is formed at one side of the protection frame, the protection frame surrounding the object partially to protect the object.

4. The hoist apparatus of claim 3, wherein the at least one object support portion is formed around the object inlet/outlet of the protection frame.

5. The hoist apparatus of claim 1, wherein the at least one object support portion comprises object support blocks having object support grooves formed to correspond to edges of the object, respectively.

6. The hoist apparatus of claim 5, wherein the object support grooves comprise a first inner contact side and a second inner contact side disposed to contact the object and disposed at right angles to each other.

7. The hoist apparatus of claim 6, wherein a length of the first inner contact side is larger than a length of the second inner contact side.

8. The hoist apparatus of claim 6, wherein a length of the first inner contact side and a length of the second inner contact side are same.

9. The hoist apparatus of claim 1, wherein the at least one object support portion comprises guide inclined surfaces on which edges of the object are guided in a direction of the object support grooves formed to correspond to the edges of the object, respectively.

10. The hoist apparatus of claim 1, wherein the at least one object support portion comprises four object support blocks in which object support grooves are formed to correspond to four edges of the object, respectively.

11. The hoist apparatus of claim 1, wherein the at least one object support portion is integrated with one side of the protection frame that surrounds the object partially to protect the object.

12. The hoist apparatus of claim 1, wherein the at least one object support portion comprises:
an object support block formed with object support grooves to correspond to four edges of the object, respectively; and
a shock-alleviating block formed of an elastic material to alleviate shock applied to the object support block.

13. The hoist apparatus of claim 1, wherein the at least one object support portion comprises:
an object support block formed with object support grooves to correspond to four edges of the object, respectively; and
an elastic spring to alleviate a shock applied to the object support block.

14. The hoist apparatus of claim 1, wherein the traveling portion is installed in such a way that a transfer leveling cart having wheels that roll along rails is connected to one side of the traveling portion.

15. A hoist apparatus comprising:
a traveling portion disposed to travel along rails; and
an object support member installed at the traveling portion, having an accommodation space in which the object is accommodated, and comprising at least one object support groove formed at one side of the object support member and having a shape corresponding to a corresponding edge of the object so as to support the object rotated with respect to the object support member.

16. A hoist apparatus comprising:
an object support member having an accommodation space to accommodate an object, and having at least one groove formed at a corresponding side of the object support member and having a shape corresponding to a corresponding edge of the object so as to support the object rotated with respect to the object support member.

17. The hoist apparatus of claim 16, wherein:
the object support member comprises at least one horizontal member and at least one object support block disposed on the horizontal member; and
the at least one groove is formed on the corresponding object support block.

18. The hoist apparatus of claim 16, wherein:
the object support member comprises at least one horizontal member; and
the groove is formed in the horizontal member.

19. The hoist apparatus of claim 16, wherein:
the object support member comprises sub-members to form a plane shape to correspond to the object; and
the groove is disposed at a plane shape having an angle with the plane shape of the object support member.

20. The hoist apparatus of claim 16, wherein:
the object support member comprises a plurality of horizontal members disposed at corners of an area;
the groove comprises a plurality of grooves disposed at corners of another area to correspond to corners of the object; and
the corners of the area and corners of the another area do not overlap.
